(19) United States
(12) Patent Application Publication
(10) Pub. No.: US 2016/0203520 A1
(43) Pub. Date: Jul. 14, 2016

(54) PROVIDING SPONSORED DATA TO A VEHICLE

(71) Applicant: General Motors LLC, Detroit, MI (US)

(72) Inventors: Swapan Das, Canton, MI (US); David George, Farmington Hills, MI (US)

(21) Appl. No.: 14/596,646

(22) Filed: Jan. 14, 2015

(51) Int. Cl. G06Q 30/02

(52) U.S. Cl. CPC G06Q 30/0267

(57) ABSTRACT

A communication system and a method for providing sponsored data service to a vehicle using a backend system that communicates with a vehicle telematics unit over a wireless carrier system. The method carried out by the system includes: establishing communication between the backend system and a wireless service provider (WSP); establishing communication between the backend system and an application service provider (ASP); coordinating, via the backend system, a sponsored data transaction for the vehicle between the WSP and the ASP; receiving an authorization from the ASP to provide sponsored data; and communicating the authorization to the WSP thereby authorizing the WSP to provide sponsored data service to the telematics unit.

### TECHNICAL FIELD

The present invention relates to providing sponsored data to a vehicle.

### BACKGROUND

Wireless service providers enable client mobile devices to make cellular voice and data calls over wide geographic regions and also track the amount of cellular data consumed thereby. For each mobile device, the service provider provides a bill corresponding to the voice and data usage of the client.

Sometimes, a third party desires to provide sponsored data to the client mobile device. From the perspective of the third party, it pays for a predefined, limited amount of data on behalf of the client and has the opportunity to advertise a sponsor's products or services to the client. From the perspective of the client, the client receives fee-free data that may be used according to the terms of a sponsored data agreement—e.g., viewing advertisements determined by the third party while using the fee-free data.

### SUMMARY

According to an embodiment of the invention, there is provided method of providing sponsored data service to a vehicle using a backend system that communicates with a vehicle telematics unit over a wireless carrier system. The method includes: establishing communication between the backend system and a wireless service provider (WSP); establishing communication between the backend system and an application service provider (ASP); coordinating, via the backend system, a sponsored data transaction for the vehicle between the WSP and the ASP; receiving an authorization from the ASP to provide sponsored data; and communicating the authorization to the WSP thereby authorizing the WSP to provide sponsored data service to the telematics unit.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is another block diagram illustrating some aspects of the communications system of FIG. 1 in greater detail;

FIG. 3 is a flow diagram of a method using the communications system of FIGS. 1 and 2;

FIG. 4 is a flow diagram of another method using the communications system of FIGS. 1 and 2; and

FIG. 5 is a flow diagram of another method using the communications system of FIGS. 1 and 2.

### DETAILED DESCRIPTION OF THE ILLUSTRATED EMBODIMENT(S)

A wireless service provider (WSP, a.k.a., a mobile network operator) experiences some technical challenges when facilitating sponsored data to its client mobile devices. Conventional techniques employed by the WSP include deep data packet inspection—e.g., filtering the header, payload, etc. of the packets seeking information indicating that the data is sponsored. This technique hampers or slows the performance of the respective Gateway GPRS Support Node (GGSN) in CDMA systems (or the Packet Gateway (P-GW) in LTE systems). Moreover, deep packet inspection limits the type of client mobile device applications that can receive and use the sponsored data. Various proprietary techniques may be employed by different WSPs presenting additional technical constraints to the third parties desiring to provide sponsored data. Thus, there is a need for providing sponsored data without hampering data communication speed, that can be used on a greater variety of mobile device applications, and that is suitable regardless of the constraints imposed by different propriety implementations of the WSPs.

The methods described below employ a backend system such as a call center, remote server, or other computing device to negotiate or coordinate a sponsored data transaction between the WSP and a third party desiring to authorize the use of sponsored data by a vehicle subscriber. The subscriber already receives services provided by the backend system. The third party may be an application service provider (ASP) which sometimes may be the sponsor itself, or may be simply facilitating the provisioning of sponsored data for multiple sponsors. Using the backend system, the WSP is capable of receiving authorization to add a quantity of sponsored data to a subscriber account and then provide the sponsored data until it is consumed. In addition, the backend system may facilitate the WSP providing additional sponsored data to the subscriber account (e.g., to avoid a service interruption) or may facilitate the WSP terminating the subscriber's use of sponsored data (e.g., before the quantity in the account is expended). A description of an illustrative mobile vehicle communication system first will be described; thereafter, various methods associated with using the system to provide the vehicle subscriber with sponsored data will be described.

### Communications System—

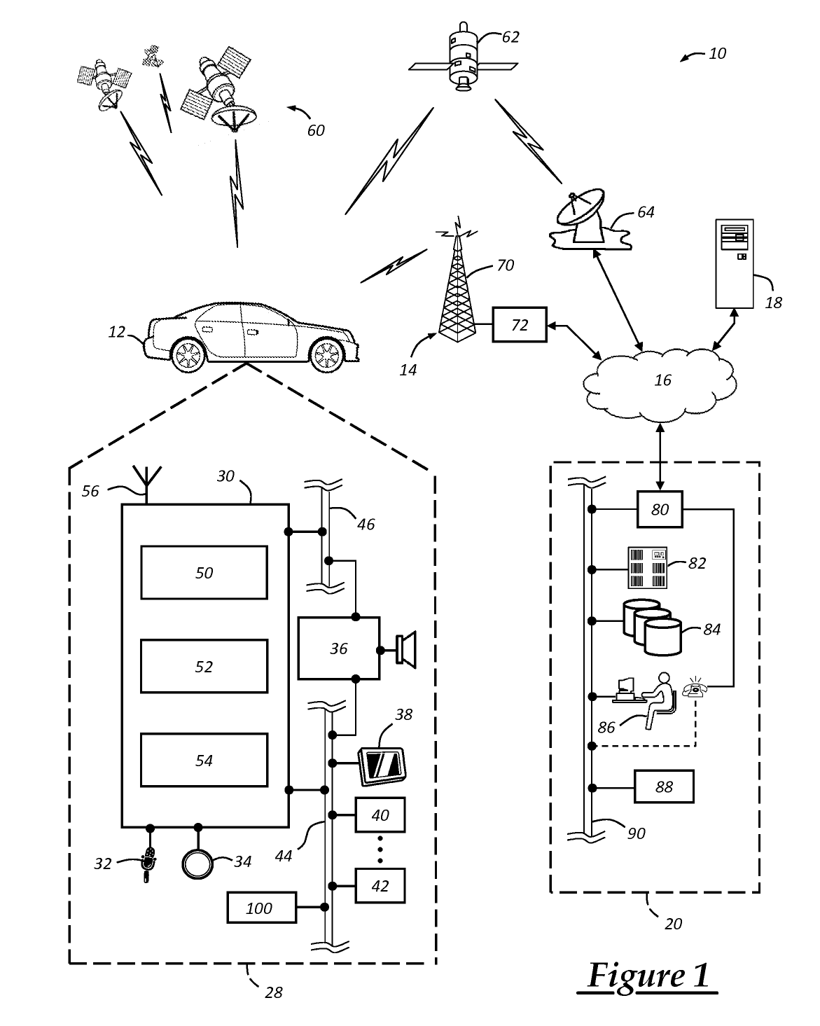

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a backend system or call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, and/or LTE standards and thus includes a standard cellular chipset 50 for voice communications like hands-free calling, a wireless modem for data transmission, an electronic processing device 52, one or more digital memory devices 54, and a dual antenna 56. It will be appreciated that other communications standards are also possible (e.g., GSM, CDMA, and LTE are merely examples). It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more suitable wireless protocols (e.g., WiMAX, ZigBee®, etc.), including any short range wireless communication (SRWC) such as any suitable Wi-Fi standard (e.g., IEEE 802.11), Wi-Fi Direct, Bluetooth, wireless infrared transmission, or various combinations thereof. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

The vehicle electronics 28 may also include a communication device such as a vehicle head unit or vehicle multi-tainment unit (VMU) 100 which may include some of the vehicle electronics previously discussed (e.g., the audio system 36, the visual display 38, etc.). As used herein, the VMU 100 may include all suitable electronics, software, etc. for providing vehicle entertainment and vehicle infotainment services to the vehicle users and/or occupants. In some instances, the VMU 100 is electronically coupled to (and in communication with) the telematics unit 30 (e.g., via bus 44 or 46). The unit 100 may be modular or may be embedded within the vehicle 12. The VMU may further include its own processor and memory; the memory may store any suitable software, firmware, etc. for VMU operation and/or interaction with telematics unit 30. Thus, the VMU may receive remote or cellular data via the telematics unit 30—e.g., connecting to the internet, the call center 20, and/or various remotely located servers and computers 18 using the communication capability of the telematics unit (or even other suitable mobile devices in the vehicle). Examples of VMUs include interactive displays in the vehicle instrument panel, interactive displays embedded within the backing of vehicle seating or the vehicle headliner, and other interactive vehicle devices/displays that are portable.

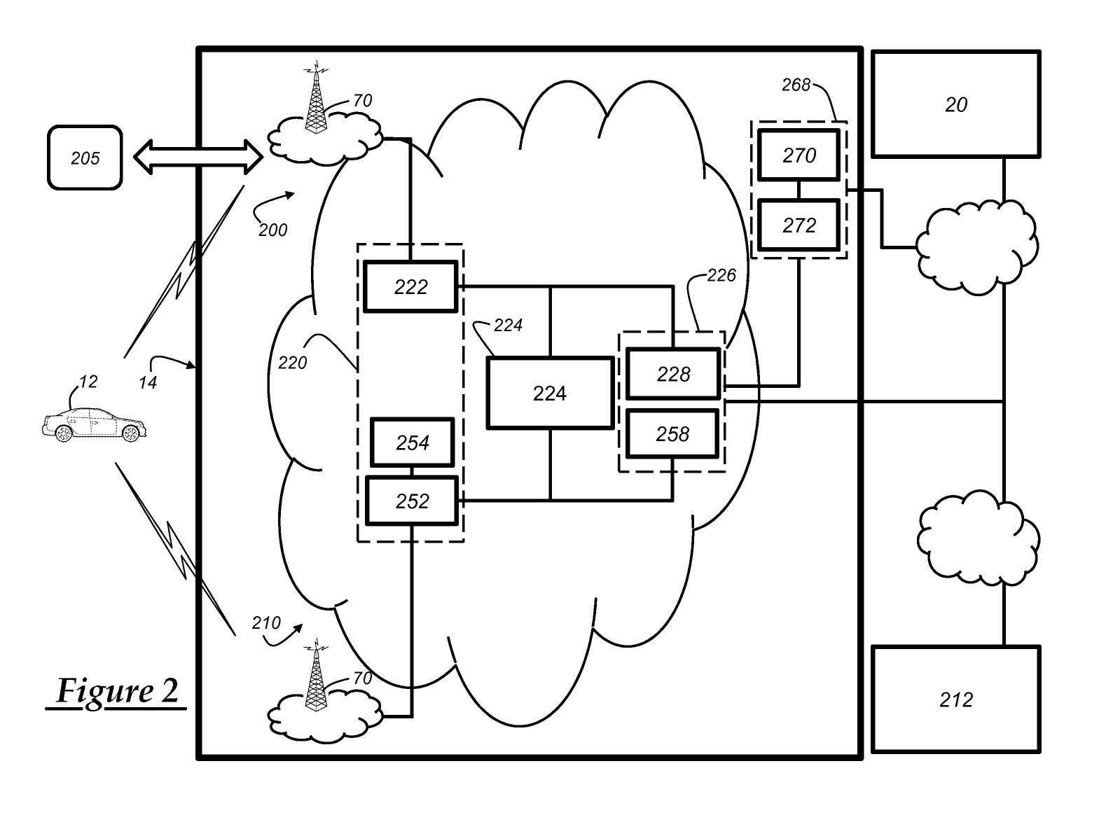

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements. FIG. 2, discussed in greater detail below, schematically illustrates two exemplary telecommunication architectures that may be used by a wireless service provider.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

The call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

A backend system may comprise the call center 20, the remote server or computer 18, and/or any suitable computing device. The backend system may coordinate communications between a wireless service provider and one or more application service providers using the afore-described wireless carrier system 14.

As discussed above, FIG. 2 illustrates two exemplary telecommunication architectures that may be used by a mobile network operator (MNO) or wireless service provider (WSP) 205: more specifically, a WCDMA or GSM architecture 200 and an LTE architecture 210 are shown. The WSP 205 may be any provider of cellular communication services and may own or control all the elements necessary to sell and deliver such services (e.g., including radio spectrum allocation, network and backhaul infrastructure, billing and customer care, among other things). Some of the elements of the carrier system 14 are shown placing the vehicle 12 in communication with an application service provider (ASP) 212, as well as the call center 20. In other embodiments, the vehicle 12 could be in communication with the ASP 212 and, instead of the call center, the remote server 18 or any other suitable backend system.

In one embodiment—according to the WCDMA or the GSM architecture 200, the vehicle 12 communicates with towers 70 electrically coupled to a first network node 220 that includes a Serving GPRS (General Packet Radio Service) Support Node (SGSN) 222 which is in communication with an access point name (APN) domain name server (DNS) 224 and a second network node 226 that includes a Gateway GPRS (General Packet Radio Service) Support Node (GGSN) 228. In addition, the APN DNS 224 and GGSN 228 are also in communication with one another. The GGSN 228 is in communication with: (1) the ASP 212 and any associated internet domain name servers; and (2) the call center 20 and any respectively associated internet domain name servers. This architecture is merely an example to illustrate the methods discussed below; e.g., the architecture may include additional SGSNs, additional GGSNs, additional APN DNSs, additional public and/or private DNSs, and additional public and/or private ASPs.

The illustrated carrier system 14 also includes a billing entity 268 that includes a charging system (CS) 270 and a policy and charging rules function (PCRF) 272 used by the WSP 205. The billing entity 268 is coupled to both the second network node 226 and the call center 20 via a private internet protocol IP. The CS 270 includes any node or entity for coordinating and/or applying charges associated with a particular subscriber's account; e.g., for tracking, monitoring, recording, billing, etc. data used by and/or available to a subscriber account associated with vehicle 12. The PCRF 272 may be a software node to determine policy rules for operation of the methods set forth herein. The configuration and operation of CS 270 and PCRF 272 are known to skilled artisans; e.g., it will be appreciated that the PCRF may be capable of accessing subscriber databases as well as the CS 270.

In another embodiment of FIG. 2—according to the LTE architecture 210, the vehicle 12 communicates with towers 70 electrically coupled to the first network node 220 that includes a Serving Gateway (S-GW) 252 which is in communication with the APN DNS 224 and the second network node 226 that includes a Packet Gateway (P-GW) 258. The S-GW 252 is shown in communication with a Mobility Management Entity (MME) 254—a control node for LTE network access. In addition, the APN DNS 224 and P-GW 258 are also in communication with one another. Similar to the GSM implementation, the P-GW 258 is in communication with: (1) the ASP 212 and any respectively associated internet domain name servers; and (2) the call center 20 and any respectively associated internet domain name servers—which also may be each in communication with one another. And, as similarly described above, this architecture 210 is merely an example to illustrate the methods discussed below; e.g., the architecture may include additional S-GWs, additional P-GWs, additional APN DNSs, additional public and/or private DNSs, and additional public and/or private ASPs.

Here again, the second network node 226 (e.g., the P-GW 258) may be coupled to the billing entity 268 described above. And again, the billing entity 268 also is coupled to the call center 20.

It should be appreciated that the first network node 220 and the second network node 226 are merely examples. In GSM, WCDMA, and LTE implementations, there may be many first and second network nodes. Similarly, there may be many APN DNS, and various ASPs. Thus, FIG. 2 is merely an example to illustrate the methods described below.

### Method—

The methods described herein include a backend system coordinating a sponsored data transaction that includes conducting communications between a wireless service provider (WSP) and one or more application service providers (ASPs) in order to enable at least one ASP to provide sponsored data via the WSP to vehicle 12 (which was previously associated with the backend system). Coordinating the sponsored data transaction further may include validating (at the backend system) that the vehicle is authorized to receive the sponsored data. The following example is illustrative of the backend system's role, at least in part. According to one embodiment, the vehicle 12 already has a subscriber account with a backend system (such as call center 20); thus, the call center 20 may have already provided services to the vehicle and vehicle users. During the sponsored data transaction, the call center communicates with the WSP (which provides wireless services to vehicle 12) and the ASP desiring to provide sponsored data. The call center may validate the eligibility of the vehicle/vehicle users to receive sponsored data using previously known identifiers (e.g., a vehicle or telematics unit ID); it may receive information regarding the terms of the sponsored data from the ASP; the call center may communicate at least some of this information to the WSP and may agree to reimburse the WSP for any costs associated with the sponsored data. As a result of the validation and terms, the WSP then provides fee-free data to the vehicle 12 according to the amount of data sponsored by the ASP. The call center also may receive monetary reimbursement from the ASP and likewise reimburse the WSP accordingly. If the user of the vehicle 12 wishes to terminate use of the sponsored data prematurely or if the ASP wishes to terminate the vehicle's use of the sponsored data, the call center may intercede on the part of the ASP ultimately revoking the sponsored data. The coordinating role of the call center eliminates the WSP's need to inspect the data for indicators that it is sponsored (e.g., no deep packet-inspection is needed) which, as will be appreciated by skilled artisans, significantly impact the quality of service (QoS) of the sponsored data—i.e., slowing data rates, and inhibiting transmission of any or all data when the sponsored data is to be used with some applications. Moreover, the coordinating role of the call center may increase user privacy; e.g., limiting or eliminating the WSP's need for packet inspection as to the content of the sponsored data.

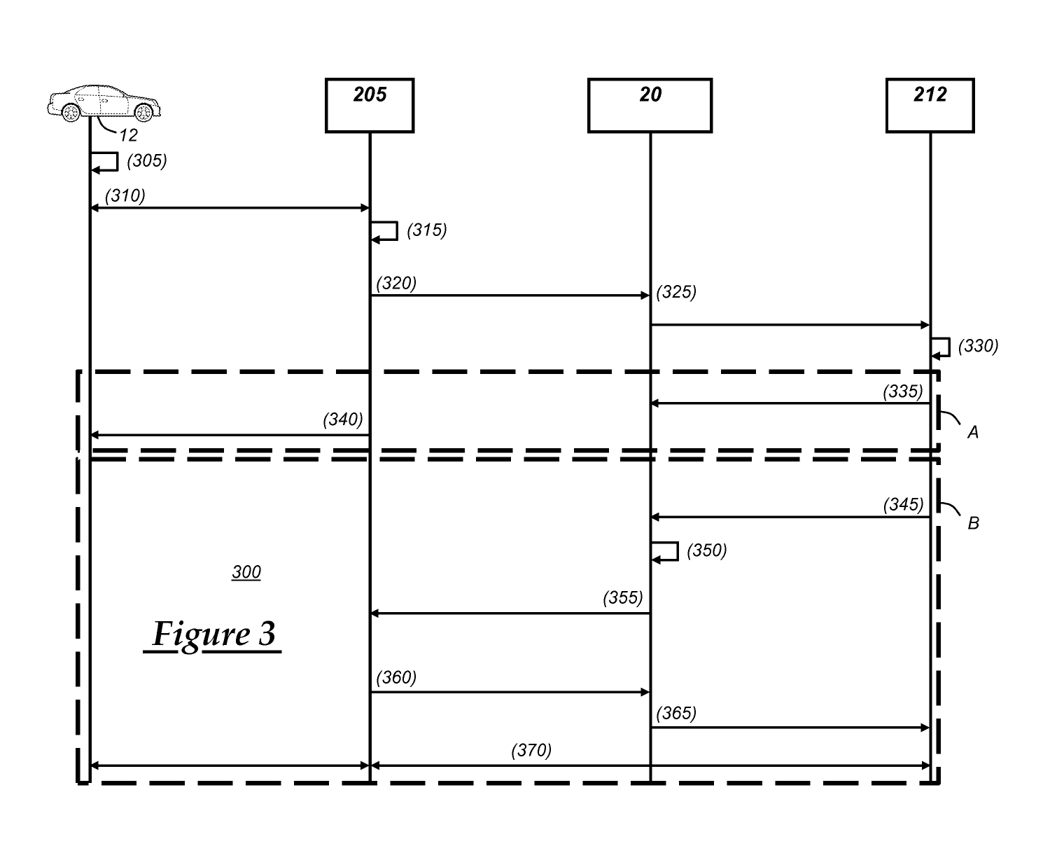

Turning now to FIG. 3, there is shown an illustrative method 300 of providing sponsored data to the vehicle 12 using the call center 20. The methods 300, 400, and 500 will be described with respect to a LTE architecture, but as previously discussed, any suitable architecture may otherwise be used. In addition, it will become apparent that all three methods (300, 400, 500) may be applied to a single vehicle in some circumstances.

The method 300 begins with step 305 wherein the vehicle 12 consumes or attempts to consume cellular data. This may include the user launching or operating an application or the vehicle running one or more background applications or maintenance communications. As used herein, the term vehicle user may be any person (driver, passenger/occupant, etc.) in or near the vehicle to requesting use of, using, or terminating the use of cellular data. For example, the user may be authorized to use the vehicle (e.g., an owner, licensee, or other authorized individual). Thus in step 305, the user may be playing music via an application (such as Pandora™) or initiating gaming software via the internet using Wi-Fi hotspot services (e.g., provided by the VMU 100 or telematics unit 30), just to name a couple examples. Following step 305, the method proceeds to step 310.

In step 310, a packet data protocol (PDP) context request is communicated between the telematics unit 30 and the WSP 205 (via S-GW 252). This step establishes a communication path (or tunnel) between the vehicle 12 and the network for data transfer. In this step, the telematics unit 30 may provide an access point name (APN) to the S-GW 252 that includes, among other things, the identity and credentials of the telematics unit in order to access the LTE network.

In step 315 (which follows step 310), the WSP may determine that no data is available to the user of the vehicle 12, meaning that, for example, the user has already used up all of his or her data allotment and so must either pay for any additional data or receive any such data as sponsored data. Of course, sponsored data could also be provided to the vehicle in other circumstances as well (e.g., prior to the consumption of all the user's data allotment). This step may include the WSP 205 checking information via the billing entity 268 (e.g., the charging system 270). In at least one implementation, the WSP 205 only checks for the availability of sponsored data. According to one rule of the PCRF 272, the WSP 205 may be required to communicate with the call center 20 when no sponsored data is currently allocated to the vehicle 12.

As a result of the determination of step 315, the WSP may establish communication with the call center 20 (step 320) in order ultimately to notify the ASP 212 that there is no sponsored data in the associated subscriber vehicle's 12 account. This may occur in a variety ways. In at least one implementation, the WSP connects to a webpage or landing page associated with the call center 20 and provides an identifier of the vehicle 12 (e.g., a mobile station international subscriber directory number or MSIDSN); e.g., this may be in accordance with a preconfigured rule in the PCRF 272. Of course, the landing page is merely one implementation to direct the WSP 205 to the call center 20; other embodiments are also possible.

In step 325 which follows, the call center establishes communication with the ASP 212 and then transmits a sponsored data inquiry thereto. The inquiry attempts to determine whether the ASP 212 desires to provide sponsored data. Then, the method 300 proceeds to step 330.

In step 330, the ASP 212 makes a determination whether to sponsor data for or on behalf of vehicle 12 (or a subscriber associated therewith). More specifically, the ASP 212 may or may not authorize sponsored data. This determination may include any suitable commercial factors, and in some scenarios, may include targeted marketing, subscribed services, based on the subscriber's demographics, subscribed services, VMU settings such as radio station presets, etc. It should be appreciated that while steps 315-325 include initiating the inquiry from the WSP, these steps also could include an initiation from the ASP 212 instead.

Following step 330, method 300 proceeds either to steps 335-340 [process A] or to steps 345-370 [process B] depending on whether the ASP 212 grants the authorization. In step 335, the ASP 212 communicates a rejection of the inquiry or a denial of authorization to the call center 20. The call center 20 may or may not communicate this denial to the WSP 205.

Regardless of whether the call center 20 communicates the denial, in step 340, the telematics unit 30 in the vehicle 12 disconnects from the WSP 205 (or at least discontinues the attempted use of sponsored data). In at least one embodiment, step 340 includes the vehicle user canceling the request to connect or the connection attempt simply timing-out. In this embodiment, the method 300 thereafter ends.

Turning to bracket B, the method 300 proceeds from step 330 to step 345. In step 345, ASP 212 authorizes a volume or quantity of cellular data that it will sponsor on behalf of the vehicle user. Of course, in some implementations this quantity may be an additional quantity. Step 345 includes communicating this authorization from the ASP 212 to the call center 20.

In step 350, the call center 20 receives the communication from the ASP 212 and, in at least one implementation, the call center validates the vehicle user's backend account. It should be appreciated that while the WSP subscriber account and the backend account may be associated with one another, these two accounts may not be one in the same. The WSP account may pertain to use of cellular voice and data services, and the backend account may pertain to other vehicle services (e.g., receiving turn-by-turn directions, road-service, etc.). Thus, in step 350, the call center 20 may validate that aspects of vehicle, telematics unit, and its user are eligible to receive sponsored data. If the backend account is validated, then the method 300 may proceed to step 355. If the backend account is not validated, then method 300 ends without proceeding. It should be appreciated that in other embodiments, the call center 20 instead may perform the validation in step 325 (e.g., before contacting the ASP 212).

In step 355, the call center 20 communicates the authorization received from the ASP 212 to the WSP 205. After which, in at least one embodiment, a series of acknowledgements may occur. For example, the WSP 205 may acknowledge receipt of the authorization to the call center (step 360). And in step 365, the call center 20 similarly may acknowledge receipt to the ASP 212. Following steps 360 and 365, the method proceeds to step 370.

In step 370, the telematics unit receives sponsored data via the WSP 205, the sponsored data being provided by the ASP 212. Moving sponsored data from the ASP 212 to the WSP 205 may occur in a variety of ways. In at least one implementation, the sponsored data never per se or physically moves from the ASP 212 to the WSP 205. Instead, the WSP 205 relies upon the call center 20 to pay for or reimburse the WSP 205 for any authorized sponsored data used by vehicle 12. And the call center 20 similarly relies upon the ASP 212 to pay for or reimburse the call center for any authorized sponsored data used by the vehicle. Following step 370, the method 300 ends.

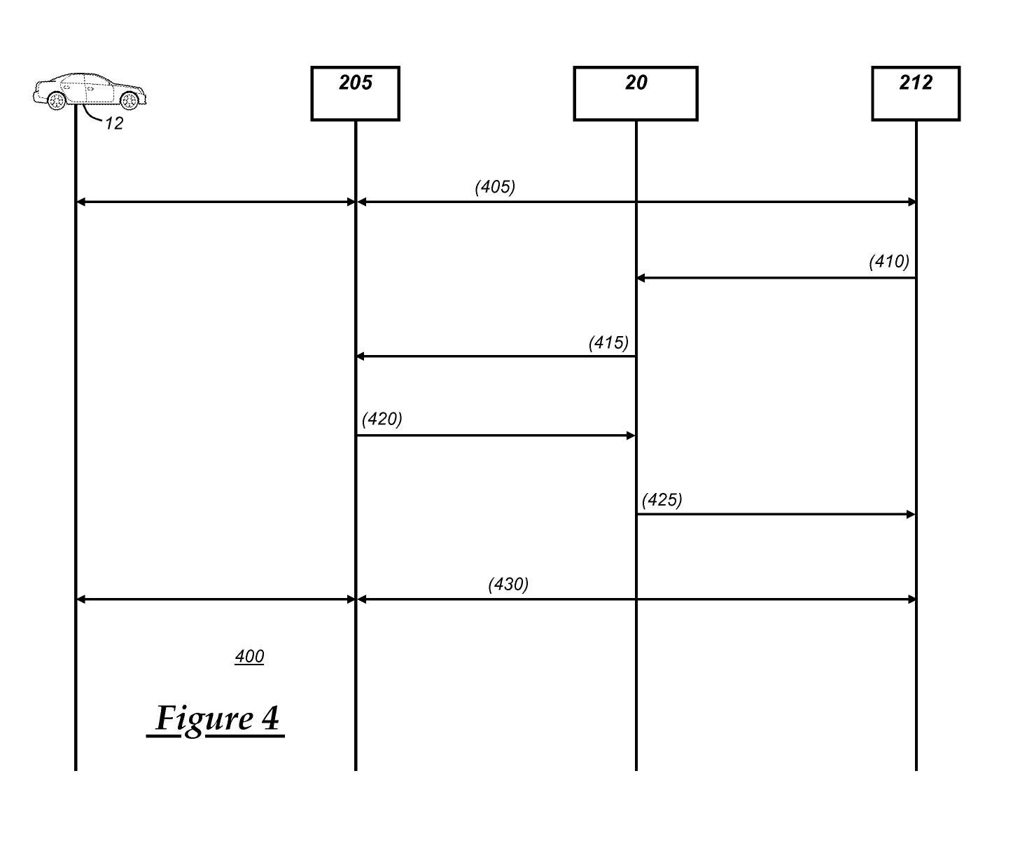

Turning now to FIG. 4, a method 400 is shown illustrating how the ASP 212 may provide additional sponsored data to the vehicle 12. The method 400 begins with step 405 wherein the vehicle 12 is currently receiving sponsored data—e.g., according to the method 300. For example, step 405 may be correlated to step 370 of the previous method. Following (or during the course of) step 405, the method proceeds to step 410.

In step 410, the ASP 212 determines to authorize an additional quantity of data for the vehicle 12 and then communicates this determination to the call center 20. This additional quantity may be of any suitable size and for any suitable reason. In one implementation, the ASP 212 performs step 410 in order to maintain a continuous or uninterrupted sponsored data experience for the user. Following step 410, the method advances to steps 415-425.

Step 415, 420, and 425 of method 400 generally may be the same as steps 355, 360, and 365, respectively, of method 300. Therefore, they will not be re-described here. And although not illustrated here, the call center 20 or other backend system may revalidate the eligibility of the user's backend account at any suitable time—including between steps 410 and 415.

Following step 425, the method performs step 430 by continuing to provide sponsored data to the vehicle user. The continued sponsored data service may or may not have been interrupted. Thus, in at least one embodiment, this additional quantity of sponsored data may be used seamlessly by the user; i.e., in at least one embodiment, the user may not be immediately aware that the earlier quantity of sponsored data was consumed and that the user is now consuming the additional quantity of sponsored data. In other embodiments, the user may need to acknowledge or affirm the receipt of the additional sponsored data before use thereof. Following step 430, the method 400 ends.

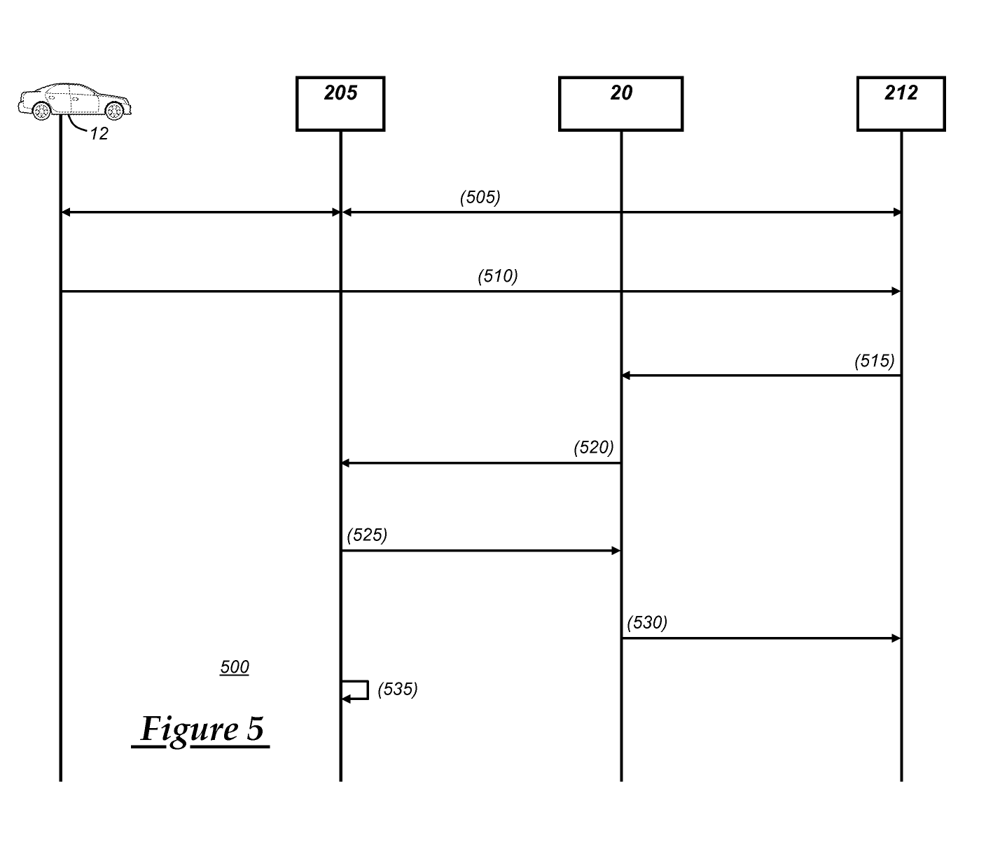

Turning now to method 500 shown in FIG. 5, here the method revokes or removes the sponsored data service. The method 500 begins with step 505 which may be the same as step 405—i.e., the user currently has access to sponsored or fee-free data via the WSP 205.

In step 510 which follows, some event triggers a termination of sponsored data service. In at least one implementation, the user revokes his acceptance of the sponsored data from the ASP 212. This may occur via the user contacting the ASP 212 directly or may occur via the call center 20 or even the WSP 205. Other sponsored data termination-triggers also exist. In one embodiment, this termination occurs relatively abruptly; i.e., without warning (e.g., as opposed to the user providing notice to the ASP 212 that, following usage of the current quantity of sponsored data, the user no longer wishes to receive such data). However the termination occurs, the method then proceeds to step 515.

In step 515, the ASP 212 issues or communicates a revocation request or termination notice to the call center 20. The revocation request may both revoke the previously granted authorization but also order the freezing or seizing of any remaining sponsored data in the WSP account (i.e., the balance of the sponsored data in the account). In so doing, the ASP 212 may not pay or reimburse the call center 20 for sponsored data consumed by the vehicle 12 following the revocation request.

In step 520, the call center may receive this request and communicate the revocation request to the WSP 205. After which, in at least one embodiment, a series of acknowledgements may occur. For example, the WSP 205 may acknowledge receipt of the revocation request to the call center (step 525). And in step 530, the call center 20 similarly may acknowledge receipt to the ASP 212. Following steps 525 and 530, the method proceeds to step 535.

In step 535, the WSP 205 terminates sponsored data service; i.e., user access to the sponsored data provided by the ASP 212. Upon receipt of the communication revoking authorization of the sponsored data (step 520), the WSP may seize or quarantine any remaining or unused sponsored data. And/or the WSP 205 may delete or freeze the remaining data—e.g., reserving it for later use, should the user change his/her mind regarding the termination. It should be appreciated that method 500 prohibits the user from using unconditionally-received fee-free data. Further, nothing in the method 500 would inhibit the user from receiving sponsored data again from ASP 212 or receiving sponsored data from other ASPs (not shown). Following step 535, the method ends.

The sponsored data service described herein is deployable by WSPs that do not have a solution for providing sponsored data and is an improvement over presently implemented methods. The sponsored data service described herein may enable wireless service having faster data rates and more user privacy. In addition, by using a backend system, sponsored data may be provided for use by a wide variety of application software available in the vehicle or to its users—unlike conventional sponsored data implementations by which some applications are unable to use sponsored data.

Thus, there has been described various methods for providing sponsored data service from an ASP to a vehicle subscriber. The vehicle backend system coordinates and facilitates initially providing the sponsored data, adding more sponsored data, and/or terminating the sponsored data service.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of providing sponsored data service to a vehicle using a backend system that communicates with a vehicle telematics unit over a wireless carrier system, comprising the steps of:
establishing communication between the backend system and a wireless service provider (WSP);
establishing communication between the backend system and an application service provider (ASP);
coordinating, via the backend system, a sponsored data transaction for the vehicle between the WSP and the ASP;
receiving an authorization from the ASP to provide sponsored data; and
communicating the authorization to the WSP thereby authorizing the WSP to provide sponsored data service to the telematics unit.

2. The method of claim 1, further comprising:
(a) receiving at the backend system a sponsored data inquiry from the WSP;
(b) communicating the sponsored data inquiry to the ASP; and
(c) when, at least partially based on the sponsored data inquiry, the ASP determines to add sponsored data to a sponsored data account associated with the vehicle, receiving at the backend system the authorization from ASP indicating that a quantity of sponsored data has been added to the data account.

3. The method of claim 2, further comprising:
(d) communicating the authorization to the WSP;
(e) receiving at the backend system an acknowledgement of the authorization from the WSP; and
(f) providing an acknowledgement from the backend system to the ASP based on step (e).

4. The method of claim 2, further comprising:
when, at least partially based on the sponsored data inquiry, the ASP declines to add sponsored data to the sponsored data account, receiving at the backend system a denial of authorization from ASP indicating that no sponsored data will be added.

5. The method of claim 2, wherein the sponsored data inquiry is based on an absence of sponsored data in the sponsored data account associated with the vehicle.

6. The method of claim 1, further comprising:
(g) after the vehicle receives sponsored data service, receiving a second authorization at the backend system from the ASP to add an additional quantity of data to a sponsored data account associated with the vehicle; and
(h) providing the second authorization to the WSP.

7. The method of claim 6, further comprising:
(i) receiving at the backend system from the WSP an acknowledgement of the second authorization; and
(j) providing an acknowledgement from the backend system to the ASP based on step (i), wherein the additional quantity of data added to the sponsored data account thereby avoiding interrupted sponsored data service.

8. The method of claim 1, further comprising:
(k) receiving from the ASP a termination notice of the authorization to provide sponsored data by the WSP; and
(l) providing the termination notice to the WSP so that access to any remaining sponsored data in a sponsored data account associated with the vehicle is frozen.

9. The method of claim 8, further comprising:
(m) receiving at the backend system from the WSP an acknowledgement of the termination notice; and
(n) providing an acknowledgement from the backend system to the ASP based on step (m).

10. The method of claim 8, wherein the termination notice is based on an indication received by the ASP indicating a vehicle user's desire to terminate sponsored data service.
